(19) United States
(12) Patent Application Publication
(10) Pub. No.: US 2009/0082094 A1
(43) Pub. Date: Mar. 26, 2009

(54) System And Method For Managing Meters In A Gaming System

(76) Inventors: Sven Hakan Andersson, Sundbyberg (SE); Jens Gustav Nilsson, Saltsjo-Boo (SE); Johan Meurling, Huddinge (SE)

Correspondence Address: MCANDREWS HELD & MALLOY, LTD, 500 WEST MADISON STREET, SUITE 3400, CHICAGO, IL, 60661, US

(21) Appl. No.: 12/163,809

(22) Filed: Jun. 27, 2008

(30) Foreign Application Priority Data
Jun. 27, 2007 (AU) 2007903463

(51) Int. Cl. A63F 9/24; A63F 13/00

(52) U.S. Cl. 463/25; 463/43

(57) ABSTRACT

A method of managing meters in a gaming system comprises a first step of temporarily storing meter information in a cache of a gaming management module. Upon receipt of an instruction from the gaming system, the meter information temporarily stored in cache is written to a storage location.

### RELATED APPLICATIONS

This application claims priority to Australian Provisional Patent Application No. 2007903463, having an international filing date of Jun. 27, 2007, entitled “A System And Method for Managing Meters In A Gaming System,” which is hereby incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The present invention relates to a system and method for managing meters in a gaming system. Embodiments of the invention find particular, but not exclusive, use in gaming machines.

### BACKGROUND OF THE INVENTION

It is often desirable or necessary to require the collection and recording of a number of events and measurement parameters that occur when a user interacts with a gaming machine or a gaming system. Such events or parameters are also called meters or meter information.

One example of a meter is a physical hardware, non-resettable (i.e. absolute) counter that registers events such as the input and output of money (e.g. the payment of bills or coins), the number of win events and the amount of each stake or bet.

Particular games may also include further counters specific to the game type.

In network based gaming systems (i.e. where a number of gaming machines are connected to a central server), it is known to send information gathered from the meters to the server, for reporting and other requirements.

In a client-server based gaming system with a large number of gaming machines connected to a number of game application servers that record data in a database there is a large number of transactions relating to the meters.

### SUMMARY OF INVENTION

In a first aspect, the present invention provides a method of managing meters in a gaming system, comprising the steps of, temporarily storing meter information in a cache of a gaming management module, and writing the meter information from the cache to a storage location on the receipt of an instruction from the gaming system.

The method may include the further step of, on receipt of the instruction from the gaming system, updating the cached meter information prior to writing the meter information to the storage location.

The instruction may be event information received from a device associated with the gaming system, such as, for example, the initiation of a game event by a user.

In more detail, the event information may be the addition of credit by a user.

The method may include the further step of requesting predefined meter information from the device, and writing the predefined information to the storage location.

The information may be deemed as committed on the successful completion of the event, and if so, a message may be returned to the system reporting the successful storage of the meter information.

The meter information may be information pertaining to a game provided by the system or information pertaining to a parameter in the device. In one embodiment, the device is a gaming device.

The storage location may be a database and the information and/or meter information may be provided in an XML format.

In a second aspect, the present invention provides a system for managing meters in a gaming system, comprising, a game management module including a cache arranged to temporarily store meter information, and a write module arranged to write the meter information from the cache to a storage location on the receipt of an instruction from the gaming system.

In a third aspect, the present invention provides a computer program arranged to, when executed on a computing system, carry out the method steps in accordance with the first aspect of the invention.

In a fourth aspect, the present invention provides a computer readable medium storing a computer program in accordance with a third aspect of the invention.

In a fifth aspect, the present invention provides a data signal comprising the computer program code in accordance with the third aspect.

### DETAILED DESCRIPTION OF THE DRAWINGS

Embodiments of the present invention will now be described, by way of example only, with reference to the accompanying drawings in which:

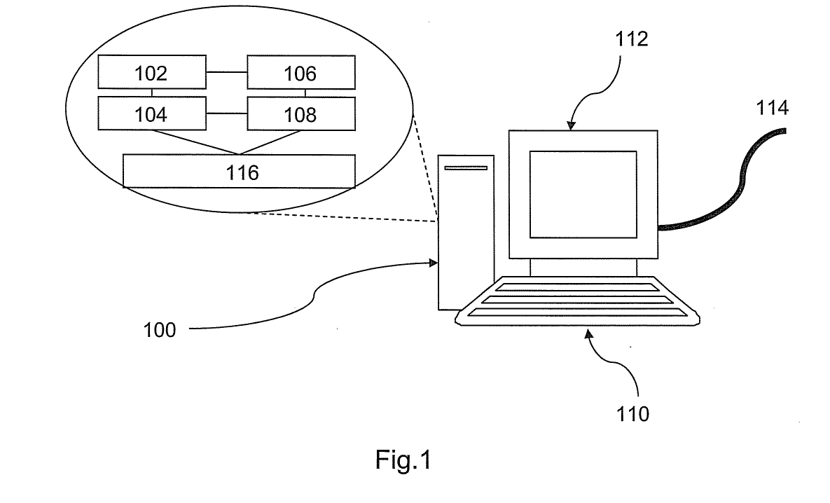

FIG. 1 is an example computing system capable of implementing an embodiment of the invention;

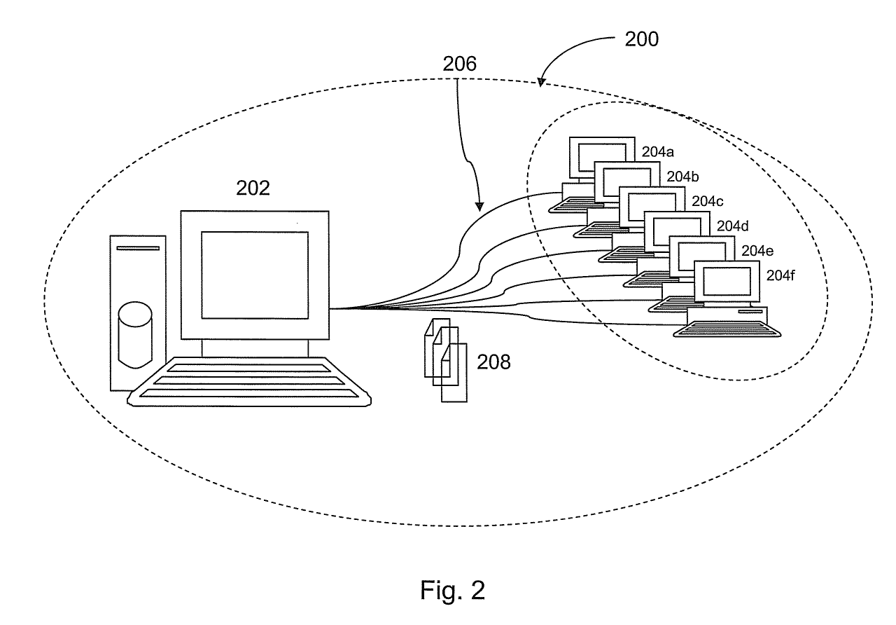

FIG. 2 is an example network environment capable of interacting with an embodiment of the invention;

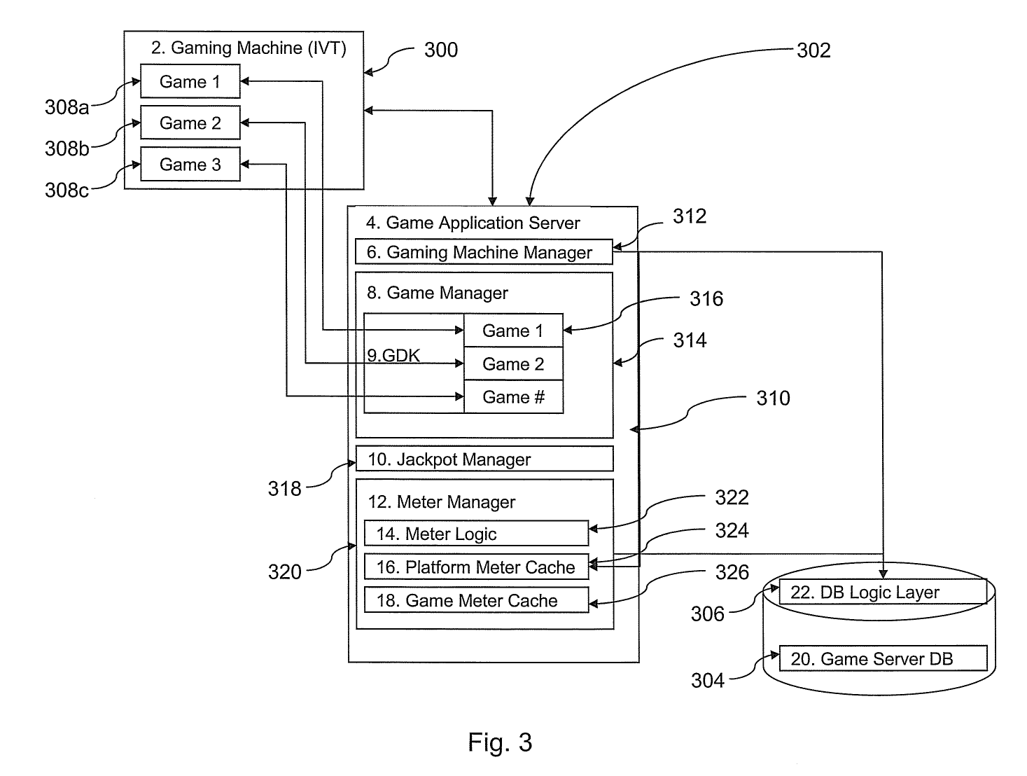

FIG. 3 is a schematic diagram illustrating the component parts of a system in accordance with an embodiment of the invention;

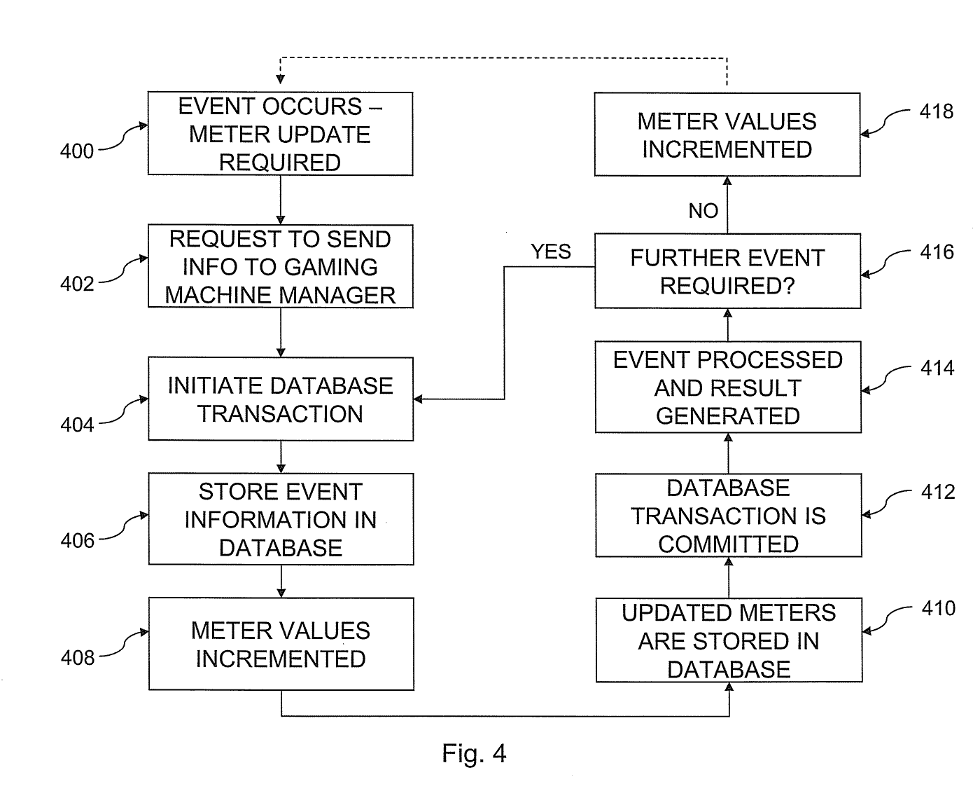

FIG. 4 is a flow chart depicting the method steps performed by an embodiment of the invention;

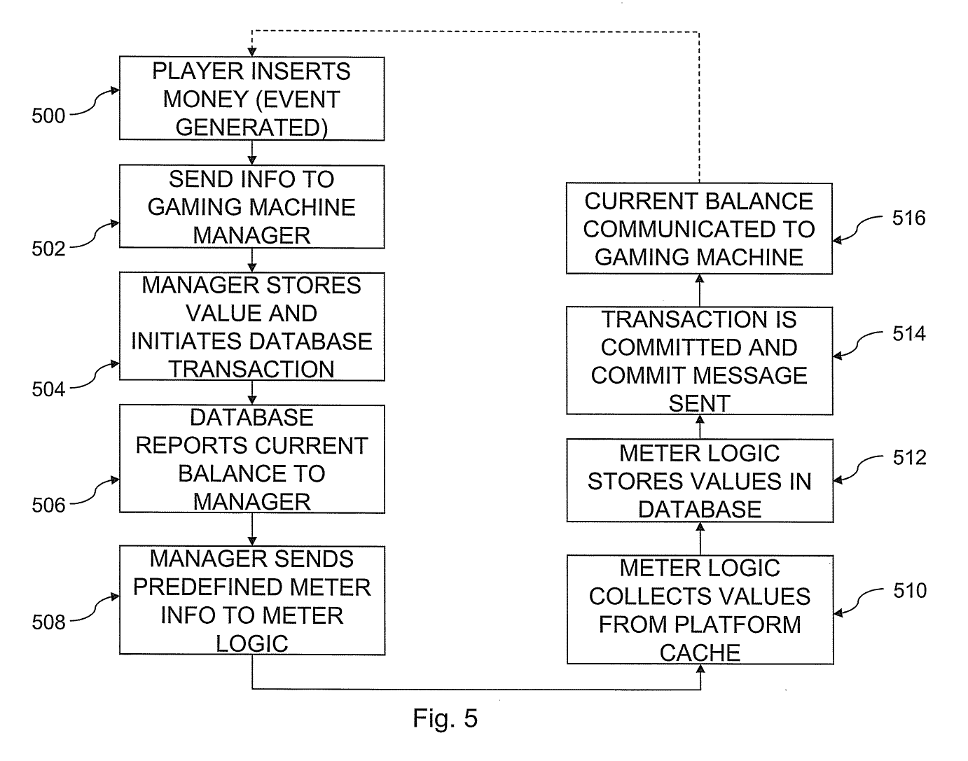

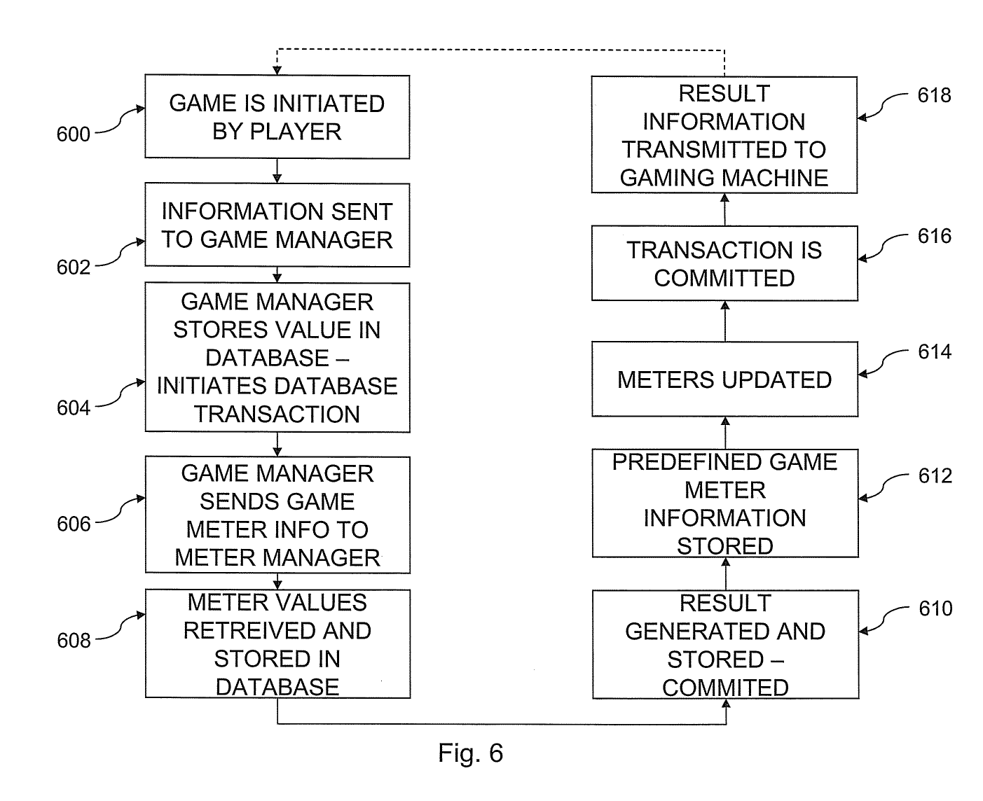

FIGS. 5 and 6 are flow charts depicting the method steps performed to execute two example transactions in accordance with an embodiment of the invention;

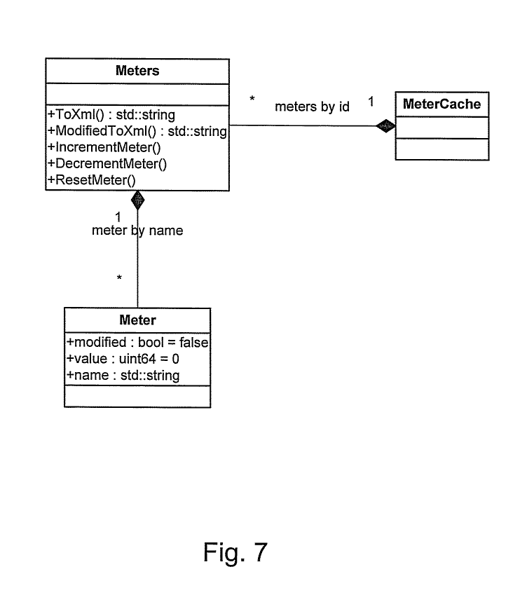

FIG. 7 is an example of a portion of a database structure in accordance with an embodiment of the invention;

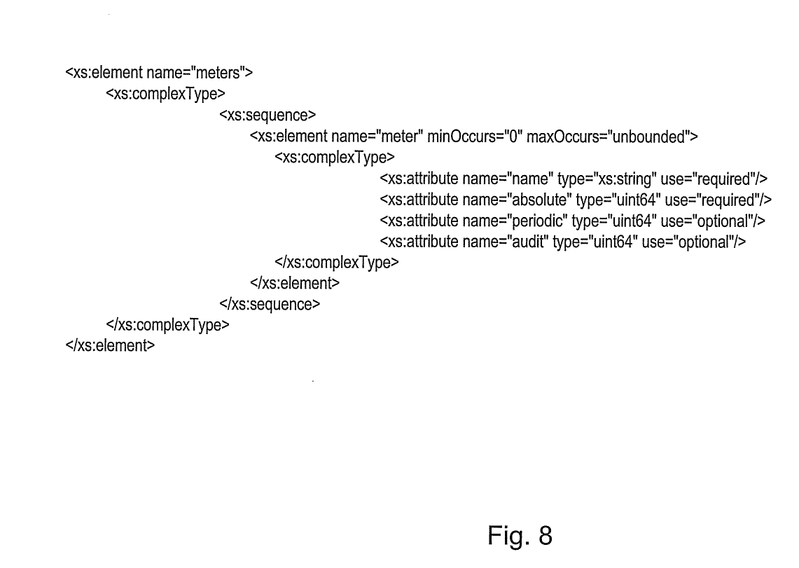

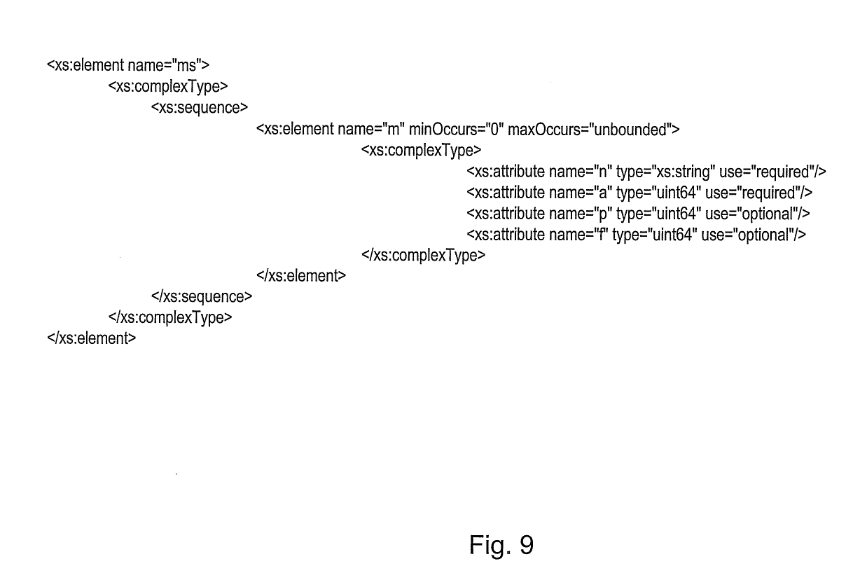

FIGS. 8 and 9 are XML Schemas utilised to transfer game meter data in accordance with an embodiment of the invention; and

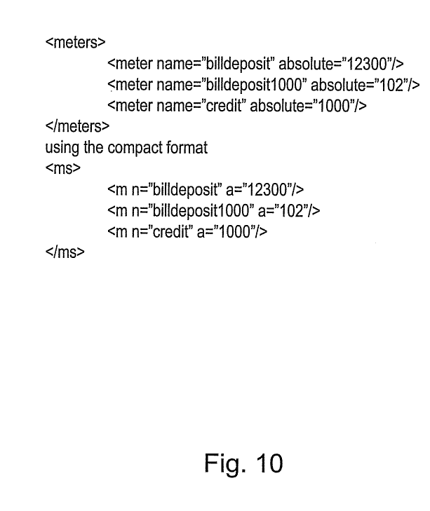

FIGS. 10, 11 and 12 are examples of XML utilised to transfer game meter data in accordance with an embodiment of the invention.

### DESCRIPTION OF AN EMBODIMENT

The present invention, in at least one embodiment, provides a method of managing meters in a gaming system. Meter information is temporarily stored in a cache of a gaming management module, and the meter information is written from the cache to a storage location. The writing occurs on the receipt of an instruction from the gaming system.

The system, method and associated software application in accordance with an embodiment of the invention may be executed on a computing system such as the example computing system shown in FIG. 1.

At FIG. 1 there is shown a schematic diagram of a computing system 100 suitable for use with an embodiment of the present invention. The computing system 100 may be used to execute applications and/or system services such as the collection, aggregation, processing and reporting of data in accordance with an embodiment of the present invention.

The computing system 100 preferably comprises a processor 102, read only memory (ROM) 104, random access memory (RAM) 106, and input/output devices such as disk drives 108, keyboard 110 (or other input peripherals such as a mouse, not shown), display 112 (or other output peripherals such as a printer, not shown) and communications link 114. The computer includes programs that may be stored in ROM 104, RAM 106, or disk drives 108 and may be executed by the processor 102.

The communications link 114 connects to a computer network but could be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive or multiple disk drives. The computing system 100 may use any suitable operating system, such as Windows™ or Unix™.

The computing system 100 may be a gaming server arranged to be networked to a plurality of gaming machines, such that information may be sent from the gaming server to one or more gaming machines, or from the one or more gaming machines to the gaming server.

The computing system 100 may be capable of executing a software application 116 (which may be in the form of an API) in accordance with an embodiment of the invention.

It will be understood that the computing system described in the preceding paragraphs is illustrative only and that the presently described embodiment or other embodiments which fall within the scope of the claims of the present application may be executed on any suitable computing system, which in turn may be realized utilizing any suitable hardware and/or software.

Other computing systems that may be suitable include server computers, hand-held or portable computing devices, consumer electronics devices, and other devices capable of receiving and/or processing electronic information, including automated ‘teller’ machines and vending machines.

FIG. 2 illustrates an example network environment 200, with a server computer 202 in communication with client computers 204a, 204b, 204c, etc., via a network (or a bus) 206, in which an embodiment of the present invention may be employed.

In more detail, the server 202 may be a gaming server, arranged to interconnect a number of gaming machines 204a, 204b, 204c, etc., via the communications network 206, which may be a local or wide area network, such as an intranet, the Internet, etc.

It will be understood that the client computers need not be gaming machines, but may be a terminal, another computing system, a portable communications device, such as a mobile telephone, or any other device capable of receiving information from the server.

The server 202, and the client devices 204a, 204b, 204c, etc., may communicate with each other over the communications network 206 by use of any suitable networking protocol, such as TCP/IP, GSA G2S (Gaming Standards Association Game-to-System protocol), GSA S2S (Gaming Standards Association System-to-System protocol) or any other suitable protocol for the exchange of information 208.

The exchange of information may include the provision of XML files, the XML files providing information to be utilized by any or all of the servers and client devices.

Referring now to FIG. 3, there is shown a schematic diagram illustrating the components of a system in accordance with an embodiment of the present invention.

FIG. 3 is a schematic diagram that depicts a system in accordance with an embodiment of the present invention. A gaming machine 300 is connected to a game application server 302. The game application server 302 is connected to (or includes) a game server database 304. The game server database 304 utilizes a database logic layer 306 to interact with the game application server 302. While the embodiment described with reference to FIG. 3 only shows one gaming machine 300 connected to one game application server 302, it will be understood that a plurality of gaming machines may be connected to the game application server 302.

The gaming machine 300 contains and is capable of executing client game software, which may allow a number of games, 308a, 308b, 308c, etc. to be played on the gaming machine.

The game application server 302 includes a plurality of software modules, including manager modules 310, wherein each manager module is arranged to manage a different function of the game application server 302.

It will be understood that each module may also contain sub-modules, arranged to perform particular functions.

In the embodiment described herein, there are included the following modules:

a gaming machine manager 312;

a game manager 314 which includes combined game application interface (GDK) and server game software modules 316 for each of games Game 1 to Game #;

a jackpot manager 318;

a meter manager 320 comprising meter logic 322, a platform meter cache 324 and a game meter cache 326.

The cache 326, in the embodiment described herein, is dynamically created in the gaming application server 302, by any appropriate method, such as, for example, the allocation or ‘blocking’ of a portion of memory in RAM or ROM.

In the specific embodiment described herein, there is provided one platform meter cache instance per gaming machine 300 that is connected to the game application server 302. In other words, there is one game meter cache per gaming machine and per game.

It will be understood that the cache, in the embodiment described, is contained in the game application server, and is arranged to hold information pertaining to a number of meters, including so-called “game specific” meters. The game application server and the platform as a whole, while containing the cache, need have no specific knowledge of the game specific meters. That is, the game specific meters may be retrieved, set and incremented by the game, wherein the gaming machine interacts directly with the game specific meter and cache.

In other words, game specific meters may be used where a game keeps statistical information that is game specific and not needed by the system as a whole for the successful execution of the game. Furthermore, additional game specific meters can be generated dynamically (i.e. post implementation) upon instruction by the individual gaming machines. For example, new game meters can be generated to cater for new regulatory requirements (e.g. to gather prescribed statistical information not already collected by the pre-existing meters) thereby allowing the machines to be implemented in that region without needing to modify the platform.

It will be understood that while, in the embodiment described, the cache 326 resides in the game application server, an alternate embodiment may include the cache in the gaming machine 300.

In the client-server based gaming system all events occurring in the course of executing a game are registered in the game server database 304. Predefined meters are also registered in the database. The meters are handled separately from but tightly coupled with the normal event registration.

The meter registration is handled in a sequence with the normal event registration as a part of an “atomic” transaction in the sense that all steps are performed or the transaction is considered not to have occurred. The transaction is managed by the logic layer 306 of the database 304.

The transaction includes two separate database storage operations that are required to have occurred before the transaction can be committed.

Referring to FIG. 4, there is described in detail the method steps by which a transaction is committed to the database 304.

The method steps in accordance with the described embodiment include:

At initial step 400, an event that requires a meter to be updated occurs in the gaming machine 300. This may be due to player input or due to some external factor (e.g. the application of credit to the machine by the game application server);
At subsequent step 402, there is triggered a request to send associated event information from the gaming machine 300 to the gaming machine manager 312 of the game application server 302;
At step 404, a database transaction is initiated;
At step 406, event information is stored in the database 304;
At step 408, the meter values are appropriately incremented;
At step 410, the updated meter values are stored in the database 304;
At step 412, the database transaction is committed;
At step 414, the event is processed and a result is generated. The event may involve calculation, random number generation or game result generation. If this is the case, then the meters may be further updated. If so, the method reverts to step 404, to store the new meter information;
At step 416, once the new meter information has been committed to the database, a result response message is generated and sent to the gaming machine 300; and
At step 418, a result presentation is generated in the gaming machine and presented to the player. After the result is displayed, the gaming machine reverts to step 400 (i.e. the gaming machine 300 waits for a new event).

Referring now to FIG. 5, there is provided a flowchart outlining the method steps performed by an embodiment of the invention when an example transaction is performed. The example of FIG. 5 describes the method steps performed when updating the platform meter.

Step 500: The Player inserts an amount of money in a gaming machine 300.
Step 502: The gaming machine 300 sends information about the amount of money inserted to the gaming machine manager 312 in game application server 302.
Step 504: The gaming machine manager 312 stores a value representing the amount of money inserted into the machine in the database 304. The value may be defined as a number of ‘credits’ available for play. In turn, a database transaction T is initiated, which is managed by the logic layer 306 of the database 304.
Step 506: The database 304 reports the current balance of credits to the gaming machine manager 312.
Step 508: The gaming machine manager 312 sends predefined meter information to the meter logic 322 of the meter manager 320.
Step 510: The meter logic 322 collects the values of each of the current meters associated with the gaming machine in the platform meter cache 324.
Step 512: The meter logic 322 stores the set of retrieved meter values in the database 304.
Step 514: The transaction T is committed and a commit message is sent by the database logic layer 306 to the gaming machine manager 312.
Step 516: The gaming machine manager 312 generates and sends a message to the gaming machine 300 with information about the current balance of credits. The current balance is presented to the player on the gaming machine and the gaming machine waits for the next input by the player.

Referring now to FIG. 6, there is provided a further flowchart outlining the method steps performed by an embodiment of the invention when another example transaction is performed. The example of FIG. 6 describes the method steps performed when updating the game meter.

Step 600: A player has started a game, selects an amount to bet and initiates a game.
Step 602: The gaming machine 300 sends information about the bet to the game manager 314 in game application server 302.
Step 604: The game manager 314 stores the bet value and possible other game related information in the database 304 and thereby starts a database transaction T1 managed by the logic layer 306 of the database 304.
Step 606: The game manager 314 sends predefined game meter information to the meter logic 322 of the meter manager 320.
Step 608: The meter logic 322 utilizes the game meter cache to update stored meter values (e.g. bet value, game round, and other game related meter information provided at step 602) and stores the updated (i.e. now current) meter values in the database 304. It will be understood by persons skilled in the art that the step of updating the meter values may involve various processing operations including incrementing the meter values, decreasing the meter values or otherwise adjusting the meter values.
Step 610: The transaction T1 is committed and a commit message is sent by the database logic layer 306 and the commit message is sent to the game manager 314.
Step 610: The game manager 314 generates a result, and stores the result information in the database 304, thereby initiating a database transaction T2 managed by the logic layer 306 of the database 304.
Step 612: The game manager 314 sends predefined game meter information to the meter logic 322 of the meter manager 320 both with regard to any affected platform meters and game meters.
Step 614: The meter logic 322 updates meters associated with the game in the platform meter cache 324 (e.g. a new balance) and in the game meter cache 326 (e.g. win count, win amount, game round start meters, game round end meters). Again, the step of updating involves appropriately adjusting the previously stored meter values to attain the current meter values (i.e. incrementing, decrementing, etc.)
Step 616: The transaction T2 is committed and a commit message is sent by the database logic layer 306.
Step 618: The game manager 314 generates and sends a message to the gaming machine 300 with result information and the result is presented to the player on the gaming machine. The machine then returns to initial step 600 to wait for next player input.

With reference to FIG. 7, there is now described an example of the data structure utilized to contain and transmit meter information in the gaming system of FIG. 3. In the present embodiment, the meter information is created, transmitted and stored in an XML format.

In more detail, meters are kept in a meter collection, wherein each meter is ascribed a different name. In the example described with reference to FIG. 7, the collection is termed “Meters”. The Meters collection is used to update meters and to generate the XML used for storage in the database and for sending meter update messages to the gaming machine.

With reference to database table 700 in FIG. 7, there are shown two example functions in the meter collection. The function ToXml generates a full meter set in XML. The function ModifiedToXml only generates a modified meter set (i.e. it returns only the meter values which have been modified since the last meter read). ModifiedToXml also clears a “modified” flag on each meter.

In one embodiment, a modified meter list may be utilized in the Meters collection instead of utilising a flag for each meter.

The MeterCache holds meters by ID (an alphanumeric identifier) and is used for the platform by client ID. Game meters will be cached by game variant ID and client ID by storing the Meters in the running game session cache for the current game by client.

FIG. 8 is an example XML Schema definition, which is used for periodic and audit (freeze) values. In a situation where space is limited in the database (for example, where an embodiment of the present invention is retrofitted into a legacy gaming system with limited memory and/or processing facilities), a compact version of the XML schema may be used. An example of such a schema is given in FIG. 9.

FIG. 10 provides some examples of XML based on the XML schemas of FIGS. 8 and 9.

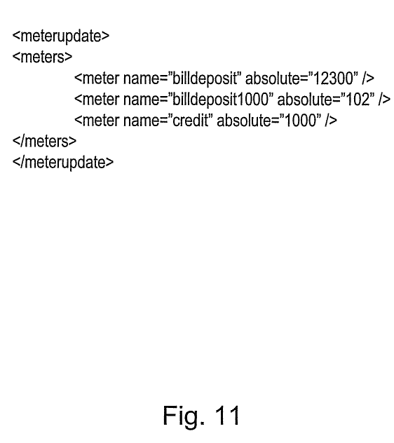

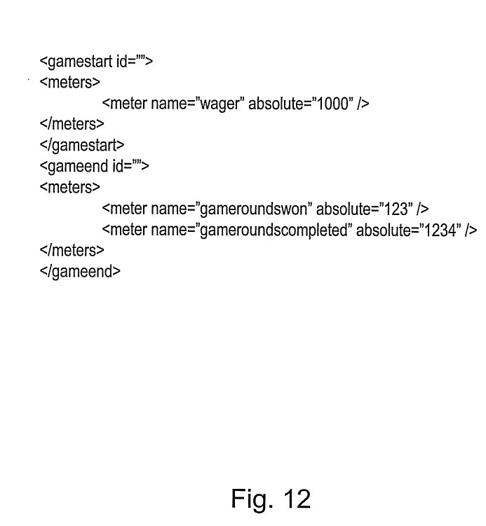

Moreover, in some situations, to reduce network traffic, it is possible to “piggyback” meter information in XML sent in response to other gaming machine requests. Examples of such piggybacks are shown in FIGS. 11 and 12, where meter information is incorporated into an XML document which has another purpose (such as sending general information to the gaming machine). In FIG. 11, an example of a piggyback for a platform update message is given, while in FIG. 12, an example of piggyback for a game meter update message is given.

That is, both platform and game meter updates can be piggybacked in the response for any request. In the case of a game meter, this may occur where a game round is ended. Game start and game end messages contain the ID attributes identifying the game in the external system.

Although not required, the embodiments described above may be implemented via an application programming interface (API), for use by a developer, and can be included within another software application, such as a gaming machine operating system or a gaming server operating system.

Generally, as program modules include routines, programs, objects, components, and data files that perform or assist in the performance of particular functions, it will be understood that a software application which carries out method steps in accordance with an embodiment of the invention may be distributed across a plurality of routines, objects and components, which correspondingly may be located across a plurality of physical hardware devices. Such variations and modifications are within the purview of those skilled in the art.

What is claimed is:

1. A method of managing meters in a gaming system, comprising the steps of, temporarily storing meter information in a cache of a gaming management module, and writing the meter information from the cache to a storage location on receipt of an instruction from the gaming system.

2. A method in accordance with claim 1, comprising, on receipt of the instruction from the gaming system, updating the cached meter information prior to writing the meter information to the storage location.

3. A method in accordance with claim 1, wherein the instruction is event information received from a device associated with the gaming system.

4. A method in accordance with claim 3, wherein the event information is the initiation of a game event by a user.

5. A method in accordance with claim 3, wherein the event information is the addition of credit by a user.

6. A method in accordance with claim 3, comprising the further step of, requesting predefined meter information from the device, and writing the predefined information to the storage location.

7. A method in accordance with claim 1, comprising the further step of deeming the information as committed on the successful completion of the event.

8. A method in accordance with claim 7, comprising the further step of, on deeming the information as committed, returning a message to the system reporting the successful storage of the meter information.

9. A method in accordance with claim 1, wherein the meter information is information pertaining to a game provided by the system.

10. A method in accordance with claim 1, whereby the meter information is information pertaining to a parameter in the device.

11. A method in accordance with claim 1, whereby the storage location is a database.

12. A method in accordance with claim 1, whereby the meter information is provided in an XML format.

13. A method in accordance with claim 1, whereby the device is a gaming machine.

14. A system for managing meters in a gaming system, comprising a game management module including a cache arranged to temporarily store meter information, and a write module arranged to write the meter information from the cache to a storage location on receipt of an instruction from the gaming system.

15. A system in accordance with claim 14, comprising an update module arranged to, on receipt of the instruction from the gaming system, update the cached meter information.

16. A system in accordance with claim 14, wherein the instruction is event information received from a device associated with the gaming system.

17. A system in accordance with claim 16, wherein the event information is the initiation of a game event by a user.

18. A system in accordance with claim 16, wherein the event information is the addition of credit by a user.

19. A system in accordance with claim 16, wherein the update module requests predefined meter information from the device.

20. A system in accordance with claim 14, wherein the information is deemed as committed on the successful completion of the event.

21. A system in accordance with claim 20, wherein a return module, on deeming the information as committed, returns a message to the system reporting the successful storage of the meter information.

22. A system in accordance with claim 14, wherein the meter information is information pertaining to a game provided by the system.

23. A system in accordance with claim 14, wherein the meter information is information pertaining to a parameter in the device.

24. A system in accordance with claim 14, wherein the storage location is a database.

25. A system in accordance with claim 14, wherein the meter information is provided in an XML format.

26. A system in accordance with claim 14, wherein the device is a gaming machine.

27. Computer program code which, when executed on a computing system, implements the method of claim 1.

28. A computer readable medium storing a computer program in accordance with claim 27.

29. A data signal comprising the program code of claim 27.
